(19) United States
(12) Patent Application Publication
(10) Pub. No.: US 2026/0268004 A1
(43) Pub. Date: Sep. 10, 2026

(54) MICROSCOPE SYSTEM, CORRESPONDING METHODS, AND COMPUTER-READABLE MEDIUM FOR VALIDATING DIGITAL FILTERS

(71) Applicant: Leica Instruments (Singapore) Pte Ltd., Singapore (SG)

(72) Inventors: Alvin KOK, Singapore (SG); Jiahao PAN, Singapore (SG); Chee Kham LIM, Singapore (SG); Shi Qi LIM, Singapore (SG); Lili ZHANG, Singapore (SG)

(21) Appl. No.: 19/072,689

(22) Filed: Mar. 6, 2025

(51) Int. Cl. G06F 21/62

(52) U.S. Cl. CPC G06F 21/6218

(57) ABSTRACT

An apparatus, method, and computer-readable medium for validating scene files in a microscope system. The apparatus comprises a microscope for capturing images, a storage device for a plurality of scene files, one or more processors, and a display. The one or more processors configured to validate a scene file of the plurality of scene files and apply one of the validated scene files to the microscope system. The display is then configured to present the captured images.

### TECHNICAL FIELD

The present disclosure relates to microscopy. In particular, it pertains to an automated validation system for filters in digital microscopes.

### BACKGROUND

In surgeries, it is essential to clearly visualize subtle anatomical features to ensure precision and successful outcomes. Modern microscopes use digital filters to adjust camera settings such as contrast, color, and exposure to help highlight or suppress specific anatomical details, enhancing visibility. However, current approaches lack methods for validating these filters to ensure secure access, prevent unauthorized modifications, and tailor functionality to the specific needs of surgeons and procedural workflows. This lack of flexibility limits the security and usability of digital microscopes scene files cannot be tailored to individual surgeons or surgical procedures. Therefore, an improved apparatus, method, and computer-readable medium for validating digital filters may be desired.

### SUMMARY

Said desire is satisfied by the subject matter defined in the independent claims.

Embodiments of the present disclosure provide a microscope system comprising a microscope for capturing images, a storage device, a storage device for storing a plurality of scene files, one or more processors configured to validate a scene file of the plurality of scene files and one of the validated scene files to the microscope system, and a display for presenting the captured images.

In some embodiments, each scene file comprises a set of image processing parameters. The parameters may include contrast, color, highlights, exposure, shadows, or aperture. A scene file may comprise an embedded digital signature, and the one or more processors are may be configured to validate the scene file by extracting the digital signature and verifying it using a corresponding public key A scene file may comprise a cryptographic hash, and the one or more processors may be configured to compute a cryptographic hash of the scene file and compare the computed hash with the cryptographic hash embedded in the scene file. The scene file may also include a timestamp, and the one or more processors may be configured to validate the scene file by comparing the embedded timestamp with the current system time to determine whether the scene file falls within a predetermined validity window.

In some embodiments, the system may be configured to receive an activation code and validate the scene file based on the activation code. The activation code may be received via a secure connection with a remote device. A secure connection may be a network connection to a server or a Bluetooth or Wi-Fi connection to a mobile device. The system may be further configured to receive the activation code from a mobile application running on the mobile device. In some embodiments, the system may be configured to receive the activation code via a user interface of the microscope system, a hardware device (e.g. USB dongles or hardware security cards), or a machine-readable optical code. The system may comprise a reader for the hardware card and be further configured to validate the activation code using the hardware card.

In some embodiments, the system may comprise a hardware-based security module for validating scene file of the plurality of scene files, wherein the one or more processors are configured to communicate with the hardware-based security module via a secure interface to perform validation of the scene file. The one or more processors may be further configured to enforce access restrictions to the scene file based on user authentication, the authentication comprising at least one of biometric verification or password entry

Additional embodiments enable workflow-based automation, where the system may obtain workflow data. The system may obtain the workflow data by detect the surgical workflow stage and automatically switching between validated scene files for optimal imaging. The system may also adjust scene file selection based on the microscope's lens configuration, connected peripherals, or user profiles, allowing for context-aware imaging settings.

Furthermore, the microscope system may interface with remote servers to download updated scene files and activation codes, which may ensure continuous access to the latest imaging configurations. In some cases, access to scene files may be restricted based on user authentication, such as biometric verification or password entry, enhancing security and compliance in controlled environments.

The aspects and features described in relation to a particular one of the previous examples may also be combined with one or more of the further examples to replace an identical or similar feature of that further example or to additionally introduce the features into the further example.

### SHORT DESCRIPTION OF THE FIGURES

Some examples of apparatuses and/or methods will be described in the following by way of example only and with reference to the accompanying figures, in which:

FIG. 1 shows a block diagram of an example of a microscope system;

FIG. 2 shows a microscope control GUI showing scene files with their corresponding validation periods;

FIG. 3 shows the customization of scene file settings on the user interface;

FIG. 4 shows scene files available on the user interface in a vitreoretinal (VR) mode setting during surgery;

FIG. 5 illustrates a flowchart depicting an example use case of an embodiment of the invention;

FIG. 6 shows a flowchart of a method for validating scene files in a microscope system; and

FIG. 7 shows a schematic illustration of a system configured to perform a method described herein.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures, same or similar reference numerals refer to same or similar elements and/or features, which may be identical or implemented in a modified form while providing the same or a similar function. The thickness of lines, layers, and/or areas in the figures may also be exaggerated for clarification.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

When two elements A and B are combined using an “or,” this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a,” “an,” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include,” “including,” “comprise,” and/or “comprising,” when used, describe the presence of the specified features, integers, steps, operations, processes, elements, components, and/or a group thereof, but do not exclude the presence or addition of one or more other features, integers, steps, operations, processes, elements, components and/or a group thereof.

Unless otherwise defined, all terms (including technical and scientific terms) are used herein in their ordinary meaning of the art to which the examples belong.

Specific details are set forth in the following description, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply that the described element item must be in a given sequence, either temporally or spatially, in ranking, or in any other manner. “Connected” may indicate elements are in direct physical or electrical contact with each other, and “coupled” may indicate elements cooperate or interact with each other, but they may or may not be in direct physical or electrical contact.

As used herein, the terms “operating,” “executing,” or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

It should be noted that the example schemes disclosed herein are applicable for/with any operating system and a reference to a specific operating system in this disclosure is merely an example, not a limitation.

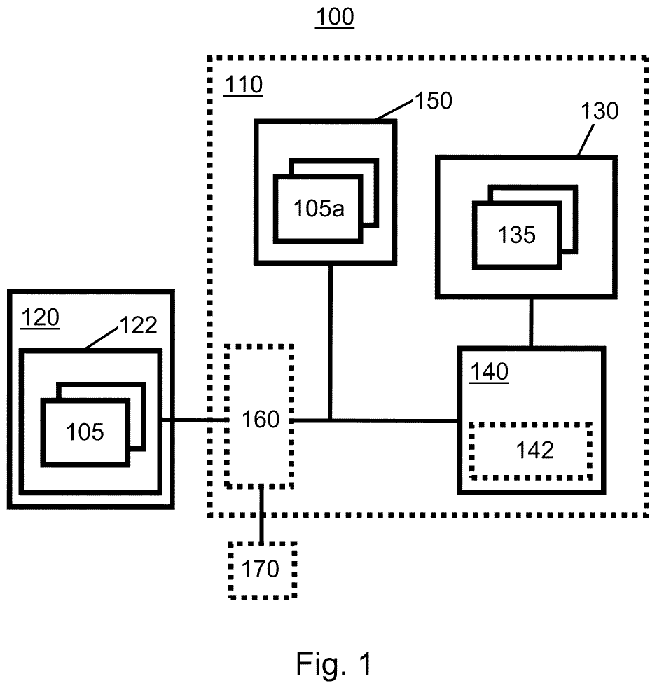

FIG. 1 shows a block diagram of an example of microscope system 100. The system 100 comprises a microscope 120 including an imaging sensor 122 for capturing images 105. The system further comprises a display 150, a storage device 130 for a plurality of scene files 135, and one or more processors 140. The one or more processors 140 are configured to validate a scene file of the plurality of scene files 135 and apply one of the validated scene files to the microscope system 100. The display 150 presents the captured images 105a with the validated scene file applied.

Optionally or alternatively, an apparatus 110 or device 110 may comprise the processor 140, storage device 135, and one or more interfaces 160 to communicate with the imaging sensor 122. The apparatus may further comprise the display 150 or communicate with the display 150 through the one or more interfaces 160.

Embodiments disclosed herein provide a flexible model for managing scene files installed on surgical microscopes. This allows for selective activation of digital filters that enhance or suppress anatomical features. Scene files may be pre-installed or downloaded via an external interface. Some scene files may remain deactivated and hidden until a license is obtained and activated. A scene file may be activated or validated through many methods, including via a remote connection, a universal serial bus (USB) dongle with an activation key, and activation codes inputted into the graphical user interface (GUI). By allowing users to obtain individual or bundled scene files specific to various workflows or anatomical needs, this system may enhance the user experience and increase adaptability for certain surgical scenarios.

A microscope system 100 may be an integrated assembly comprising optical, mechanical, and electronic components for magnifying and imaging specimens. An imaging sensor 122 may be a device, such as a CCD or CMOS sensor, that captures light from the specimen and converts it into digital image data 105. A storage device 130 may be a hardware component, such as a hard drive or solid-state drive, used for storing digital data, including image files and associated metadata. A processor 140 may be a central processing unit(s) responsible for executing software instructions to control various functions of the microscope system, including image processing and user interface management. A display 150 may be a visual output device, such as an LCD or OLED screen, that presents images and data to the user.

The interface circuitry 160 or means for communicating 160 may correspond to one or more inputs and/or outputs for receiving and/or transmitting information, which may be in digital (bit) values according to a specified code, within a module, between modules or between modules of different entities. For example, the interface circuitry 160 or means for communicating 160 may comprise circuitry configured to receive and/or transmit information.

For example, the processing circuitry 140 or means for processing 140 may be implemented using one or more processing units, one or more processing devices, or any means for processing, such as a processor, a computer, or a programmable hardware component being operable with accordingly adapted software. In other words, the described function of the processing circuitry 140 or means for processing 140 may be implemented in software, which is then executed on one or more programmable hardware components. Such hardware components may comprise a general-purpose processor, a Digital Signal Processor (DSP), a microcontroller, etc.

For example, the storage circuitry 130 or means for storing information 130 may comprise at least one element of the group of a computer-readable storage medium, such as a magnetic or optical storage medium, e.g. a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The apparatus 110 may comprise memory circuitry, machine-readable instructions, and processor circuitry to execute the machine-readable instructions. The apparatus may be part of a system. For example, the processing circuitry may be configured to provide the functionality of the apparatus in conjunction with the interface circuitry. The interface circuitry is configured to exchange information (e.g., with other components inside or outside the apparatus and the storage circuitry). Likewise, the device may comprise means configured to provide the functionality of the device.

The components of the device are defined as component means, which may correspond to, or be implemented by, the respective structural components of the apparatus. For example, the device of FIG. 1 comprises means for processing, which may correspond to or be implemented by the processing circuitry (e.g. a processor, a computer, or a programmable hardware component), means for communicating, which may correspond to or be implemented by the interface circuitry, and (optional) means for storing information, which may correspond to or be implemented by the storage circuitry (e.g. a non-transitory, computer-readable medium). The following illustrates the device's functionality with respect to the apparatus. Features described in connection with the apparatus may thus likewise be applied to the corresponding device.

In general, the functionality of the processing circuitry or means for processing may be implemented by the processing circuitry or means for processing executing machine-readable instructions (e.g. a program code). Accordingly, any feature ascribed to the processing circuitry or means for processing may be defined by one or more instructions of a plurality of machine-readable instructions. The apparatus or device may comprise the machine-readable instructions, e.g., within the storage circuitry or means for storing information.

In an embodiment, each scene file may comprise a set of image processing parameters. Embodiments disclosed herein introduce a validation feature that allows users to activate scene files, which are collections of digital filter settings designed to enhance specific anatomical features or change the visualization settings of the surgical field. A scene file 135, may be a digital file containing predefined parameters and settings used to process and display images captured by the microscope system. Scene files or digital filters may enhance or suppress anatomical features by adjusting camera settings. Validation of these scene files allows users to selectively activate and apply these settings based on their specific needs and workflows. This may ensure that users can access only the most relevant settings, improving efficiency and adaptability in different applications.

With validation mechanisms, scene files can be selectively enabled, allowing for a more streamlined and adaptable system configuration. Users may activate only the necessary features, reducing complexity and ensuring an optimized user experience. Validation supports a structured approach to system functionality, allowing for a core configuration that can be expanded with additional scene files as required. This may ensure a more focused and efficient system setup, improving usability while maintaining adaptability for different levels of operation.

Image processing parameters may be settings and values applied to raw image data to enhance or modify visual characteristics. These parameters may include adjustments to contrast, color balance, exposure, shadows, sharpness, and aperture to modify the captured images for improved clarity and visualization. The processor may apply these parameters to the image in real time, allowing for optimized viewing based on user preferences or procedural requirements.

Contrast is the degree of difference between an image's lightest and darkest areas, affecting its overall tonal range. Color balance may refer to attributes of the image related to hue, saturation, and brightness, which can be adjusted to represent the specimen accurately. Highlights are the brightest portions of an image, which may be adjusted to prevent overexposure and retain detail. Exposure is the amount of light allowed to reach the imaging sensor, determining the brightness of the captured image. Shadows are the darkest areas of an image, which can be modified to reveal detail without compromising overall contrast. The aperture is an adjustable opening in the optical path that controls the amount of light entering the imaging system, influencing exposure and depth of field. Scene files may then alter the microscope's state or mechanics to change the image captured by the microscope's image sensor.

Scene files may contain predefined settings to improve visualization of anatomical features based on surgical needs. These settings may also be customizable or have customizable ranges that a user can set. Examples of predefined scene files may include blue or green enhancement, contrast adjustment, and monochrome.

In surgical settings, such as optometry, blue or green enhancement may improve the visibility of the epiretinal membrane during membrane peeling procedures. Contrast adjustment may enhance the view of the vitreous in posterior segment surgeries. Monochrome may enhance the edges of the membrane during capsulorhexis (a step of cataract surgery) and the visibility of blood vessels in the retina.

In an embodiment, the one or more processors may be configured to validate a scene file based on an activation code. An activation code may be a unique alphanumeric string used to enable or unlock specific features or functionalities within the microscope system's software. Validation may ensure the authenticity and integrity of a scene file or software component to ensure it has not been tampered with and is from a trusted source.

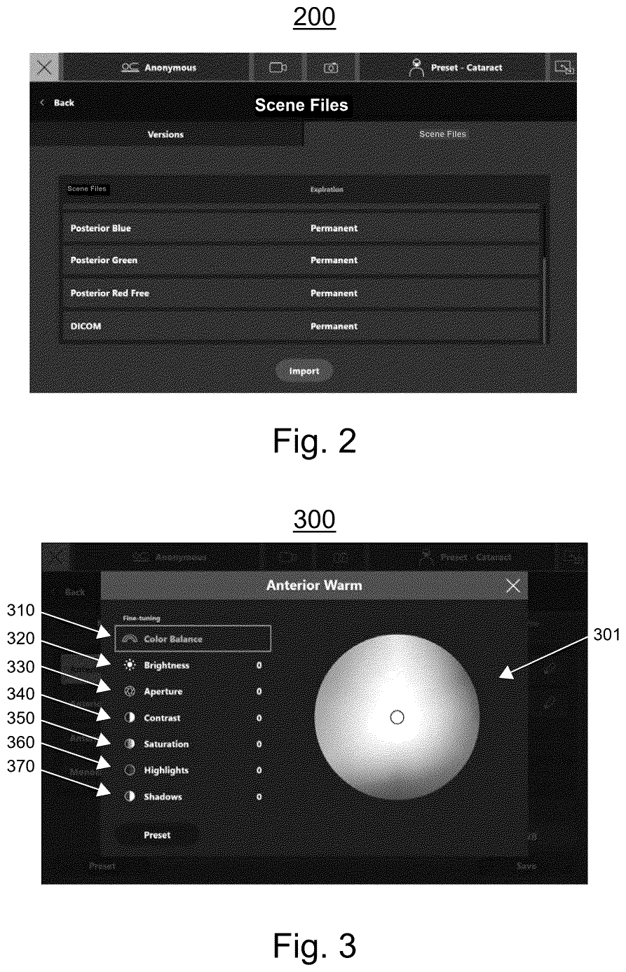

Scene files may be pre-installed on the surgical microscope but remain deactivated until activated by a user. This may eliminate the need for additional software installations, simplify the activation process, and ensure the system remains operational without requiring manual file transfers or updates. Scene files may only be valid for a certain time period. This can ensure that they are current. FIG. 2 shows a microscope control GUI 200 showing scene files with their corresponding validation periods. Examples of such preset licenses include “Posterior Blue,” “Posterior Green,” “Posterior Red Free,” and “DICOM.” Each license has a corresponding expiration status. In this case the status for each scene file marked as “Permanent,” indicating unrestricted, indefinite access to these functionalities. The GUI also provides an option to import additional scene files. The interface may further be configured to present additional metadata, such as scene file authorship, feature descriptions, or expiration alerts, thereby offering a comprehensive control mechanism for managing the microscope's imaging capabilities.

In an embodiment, the activation code may be received via a secure connection to a remote device 170. A remote device is an external device, such as a computer or mobile device, that can connect to the microscope system 100 over a network to access or control its functions. A secure connection may be an encrypted communication link between devices to protect data transmitted over networks from unauthorized access. The secure connection may pass through the system's one or more interfaces 160.

This secure connection may be a network connection to a server. Network connections are communication pathways, either wired or wireless, that allow the microscope system to interface with external devices or networks, such as the internet or local intranet. A server is a dedicated computer system that provides services, such as data storage or processing capabilities, to the microscope system over a network.

An activation code for a scene file may be received remotely via an Internet connection. The microscope system may establish a communication link with a remote server to retrieve an activation code and enable selected scene files. Remote activation may facilitate instant access to required functionalities while minimizing the need for on-site technical support.

In an embodiment, the secure connection may be a Bluetooth or Wi-Fi connection and the one or more processors may be configured to receive the activation code from an application running on the remote device 170, which may be a mobile device. A mobile application running on a remote device, such as a smartphone or tablet, may be used to provide an activation code for the scene files. The remote device may establish a communication link with the microscope system via a wireless connection, such as Bluetooth or Wi-Fi, and transmit an authentication signal to activate scene files. The mobile device may be registered with the microscope system in some embodiments. Scene files may be associated with the mobile device and may be deemed valid when a known mobile device is connected to the microscope system. This may provide users with a convenient, mobile-based activation solution.

In some embodiments, one or more processors 140 may be configured to validate a scene file based on an activation code received via a user interface. Validation may be performed via manual entry of an activation code through the microscope system's graphical user interface (GUI). A user may input a unique activation code using an on-screen keyboard or a connected input device, whereupon the one or more processors may validate the code and enable the corresponding scene files. This method may provide an alternative activation means without reliance on external hardware.

In some embodiments, one or more processors 140 may be configured to scan a machine-readable optical code using an integrated imaging sensor to validate a scene file. A machine-readable optical code is a visual pattern, such as a barcode or Quick-Response (QR) code, that can be scanned and interpreted by optical devices to convey information. It is often used for activation or authentication purposes.

Validation may be performed by scanning a machine-readable optical code, such as a QR code, using an integrated imaging sensor in the microscope system. Upon detection and decoding of the optical code, the one or more processors may retrieve the corresponding activation data and enable the associated scene files. This approach may allow seamless activation using a printed or digitally displayed code.

In some embodiments, one or more processors 140 may be configured to validate a scene file based on an activation code received via a hardware device inserted into the microscope system. The hardware device may connect to the system via the one or more interfaces 160. A hardware device is a physical component used to authenticate or enable specific functionalities within the microscope system.

The device may be a USB dongle or a hardware card containing the activation code, which is validated using a built-in reader. A USB dongle may be a small hardware device that connects to a USB port. A hardware card may be a physical card embedded with data or codes used for authentication or activation purposes within the system. These mechanisms may ensure secure access control and prevent unauthorized usage of scene files.

Validation may be performed via a USB dongle equipped with an activation key. Upon insertion of the USB dongle into the microscope system, the one or more processors may retrieve and validate the activation key, enabling access to the corresponding scene files. This approach may provide a secure and efficient method for granting access to authorized scene files without requiring an Internet connection.

Validation may be performed via embedded hardware licensing, wherein a hardware card containing a pre-stored activation key may be inserted into a corresponding reader within the microscope system. The one or more processors may retrieve the activation data from the hardware card and validate it before enabling the corresponding scene files. This approach may offer a secure, hardware-based method for managing access to licensed features.

In an embodiment, each scene file 135 may further comprise an embedded digital signature, and the one or more processors are configured to validate the file by extracting the signature and verifying it with a corresponding public key. A digital signature is a cryptographic value generated using a private key, appended to data to verify its origin and integrity. A public key is a cryptographic key that can be freely distributed and is used in conjunction with a private key to decrypt messages or verify digital signatures.

Alternatively, the scene file 135 may have a cryptographic hash, where the processor computes a new hash from the file and compares it against the pre-stored hash to detect modifications or tampering. A cryptographic hash is a fixed-length string of characters produced by a hash function, uniquely representing data to detect changes or tampering. A computed hash is a string generated by the system's processor from a file or data set, used to compare against a known hash for validation purposes. When the computed has for a scene file matches a known has for the scene file the scene file may be validated.

In some embodiments, each scene file 135 contains a timestamp, and the system validates the file by comparing the timestamp to the current system time to ensure the scene file is used within a predefined validity window. A timestamp is a record indicating the specific date and time an event occurred, often used to track changes or access events within the system. These security mechanisms may provide integrity verification, authenticity checks, and controlled usage periods for scene files.

In an embodiment, the microscope system 100 may include a validation module 142 for verifying scene files. A validation module may be a hardware component responsible for checking the authenticity and integrity of files or operations within the system. The validation module may be hardware-based, allowing the processor to communicate with it via a secure interface to perform tamper-resistant validation of the scene file. A dedicated physical component may be designed to manage cryptographic keys, perform secure operations, and communicate with the system via a protected communication channel that may ensure data exchanged between components is encrypted and secure from interception or tampering. This hardware-based security approach may enhance data integrity, prevent unauthorized modifications, and enforce compliance with regulatory standards.

For example, the validation module may comprise a Trusted Platform Module (TPM) configured to store cryptographic keys and perform secure boot and file integrity checks. In another embodiment, the validation module may include a Hardware Security Module (HSM) that may provide tamper-resistant key storage and cryptographic operations such as encryption, decryption, and digital signature verification. The validation module may alternatively be implemented using a Field-Programmable Gate Array (FPGA), which may enable real-time validation of scene files by executing custom cryptographic functions in parallel. In some implementations, the validation module may include a Secure Element (SE), such as an embedded security chip that manages authentication and encrypted communication. In other embodiments, the validation module may utilize a Trusted Execution Environment (TEE), to isolate security-critical operations from the main processor and prevent unauthorized modifications. Additionally, the validation module may be implemented using a cryptographic co-processor, which offloads encryption and verification tasks to dedicated hardware, thereby enhancing security and performance.

In an embodiment, the one or more processors 140 may enforce access restrictions to scene files based on user authentication. For security, the processor 140 may use digital signatures, cryptographic hashes, and timestamp-based validation to ensure scene file integrity. The system can receive activation codes via multiple methods, including network connections, USB dongles, and QR code scanning. Further embodiments integrate biometric authentication, workflow-based automation, and cloud connectivity to provide secure, user-specific, and dynamically adaptable imaging solutions.

Authentication may include biometric verification (i.e. fingerprint or facial recognition) or password entry to ensure that only authorized users can access specific scene files. User authentication is the process of verifying a user's identity before granting access to system features or data, typically involving credentials like usernames and passwords. Biometric verification is one authentication method that relies on unique physiological characteristics, such as fingerprints or facial recognition, to confirm a user's identity.

Scene files may also be associated with surgeon profiles, allowing each surgeon's preferred settings to load automatically upon login. This feature personalizes the experience and reduces setup time before surgeries. Scene files may be customized to suit each surgeon's preferences, and the optimized settings may be saved to the surgeon profile. FIG. 3 shows the customization of scene file settings on the user interface. It illustrates a GUI depicting a color adjustment interface featuring a color wheel 301 as one selection tool for 300 for a scene file called “Anterior Warm.” The color wheel enables a user to modify color balance by selecting a point within the circular spectrum, thereby adjusting an image's hue and tonal composition. Adjacent to the color wheel, a color balance selection button 310 is depicted in an activated state, indicating that the interface is currently set to adjust the color balance. Below and alongside the color wheel, a plurality of adjustment controls 320, 330, 340, 350, 360, 370 are arranged, each corresponding to different image attributes, including brightness 320, aperture 330, contrast 340, saturation 350, highlights 360, and shadows 370. These controls may be implemented as sliders, buttons, or other input mechanisms, enabling real-time manipulation of respective image properties. The GUI is designed to provide intuitive and precise control over image adjustments, facilitating seamless color correction and tonal refinement. The interface may include real-time preview functionality, allowing users to visualize changes before applying modifications. shows a color. This customization may be saved to an individual surgeon's profile.

The system may also offer subscription-based licenses, providing users access to regular updates, new scene files, and any enhancements. Scene file licenses may be purchased individually or bundled according to workflow requirements (e.g. retina or cornea) or specific microscope modes (e.g. anterior or vitreoretinal mode). These options provide flexibility for the user and the system administrator.

The microscope system may also interface with a surgical information system to obtain workflow data. Based on this data, the processor may only enable restricted scene files during specific surgical workflow steps. Surgical information systems are digital platforms that manage and integrate surgical workflow data, including patient information, procedural steps, and real-time imaging data. Workflow data may include information associated with a structured sequence of actions within a procedure used to automate or optimize the operation of the microscope system. A scene file may require special permissions or authentication before being accessed or applied within the system. This may ensure context-aware security and prevent accidental or unauthorized scene file activation outside its intended use case.

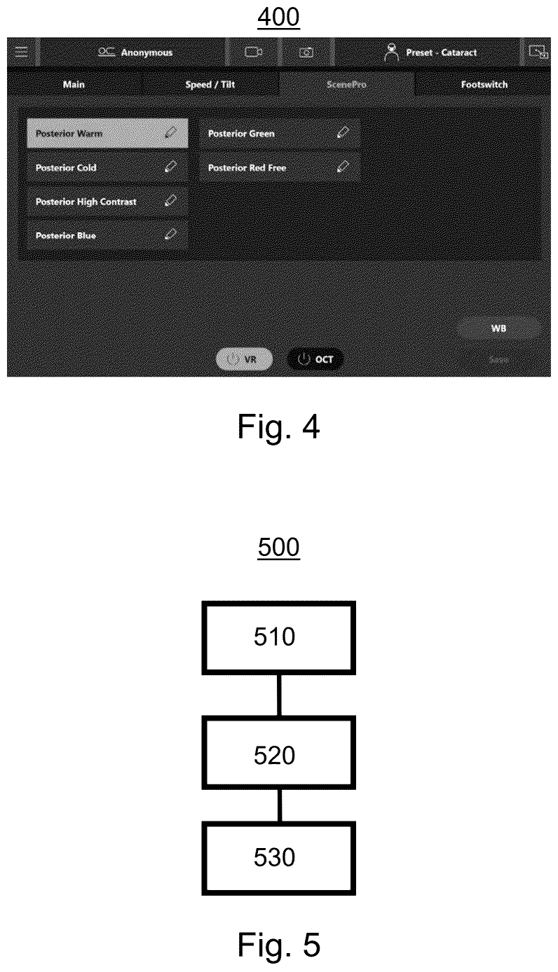

In an embodiment, the microscope system is configured to detect the current workflow step and automatically switch between validated scene files corresponding to different workflow stages. Scene files may be tied to specific workflow steps, enabling automatic activation based on the surgical phase. FIG. 4 shows scene files available on the GUI 400 in a vitreoretinal (VR) mode setting during surgery. For example, an anterior-focused scene file can be automatically applied during cataract surgery at the start. The microscope camera may automatically switch to a posterior scene file for steps like vitrectomy during vitreoretinal surgery.

The GUI may be segmented into multiple tabs, such as Main, Speed/Tilt, Scene (ScenePro), and Footswitch, allowing the user to navigate between different system configurations efficiently. Within the Scene tab, a variety of posterior scene files are presented, including “Posterior Warm,” “Posterior Cold,” “Posterior High Contrast,” “Posterior Blue,” “Posterior Green,” and “Posterior Red Free.” The ability to toggle between these scene files enables surgeons to apply optimal visualization settings tailored to specific procedural needs.

In an embodiment, scene files are dynamically linked to the workflow, allowing real-time adjustments in response to procedural transitions. For instance, an anterior-focused scene file may be automatically selected at the onset of a cataract surgery, optimizing visualization of the anterior segment. As the procedure advances to posterior segment interventions—such as vitrectomy—the microscope system can automatically transition to a posterior scene file, such as Posterior Red Free for enhanced visualization of retinal structures.

Additionally, in some embodiments a user may select the edit icons next to each scene file to modify or customize imaging parameters, allowing for personalized workflow adaptations. At the bottom of the interface, there are VR and OCT toggle switches, indicating the ability to activate Vitreoretinal mode (VR) and Optical Coherence Tomography (OCT) imaging, further enhancing the surgeon's intraoperative visualization capabilities.

The automated scene file switching mechanism may ensure that surgeons are provided with the most clinically relevant imaging settings at each stage of surgery, minimizing manual adjustments and streamlining intraoperative efficiency. Furthermore, integration with workflow detection algorithms may enhance microscope automation, reducing cognitive load on the surgeon while maintaining optimal visualization conditions.

In an additional embodiment, the system may detect the lens configuration of the microscope and select an appropriate scene file based on the detected configuration. In some embodiments, the processor 140 applies scene file settings dynamically, adjusting parameters such as contrast, exposure, and color based on the lens configuration or workflow step.

Lens configuration is the specific arrangement and type of optical elements in the microscope system, which may be adjustable or preset based on user requirements. In some embodiments, one or more processors restrict the activation of a scene file based on the configuration of the microscope or a connected peripheral. Connected peripherals may be any external device that interfaces with the microscope system, such as a foot pedal, camera module, or lighting accessory. Only the appropriate scene files may be available when a certain microscope configuration or connected peripherals are detected.

Further, the system may enable customized scene file activation based on a user profile stored in the storage device. The user profile may contain specific parameters that determine how and when certain scene files are activated. User profiles may store a set of user-specific settings and preferences, including interface customization, imaging parameters, and access permissions. This allows personalized settings for different users and hardware configurations, optimizing the microscope system for individual workflows.

In an embodiment, the microscope system is configured to connect to a remote server to download updated scene files and activation codes. Additionally, the system may receive signals from a connected peripheral and automatically switch between scene files based on these signals. These capabilities provide real-time adaptability, automated updates, and integration with external medical systems to enhance usability and accuracy.

FIG. 5 illustrates a flowchart 500 depicting an example use case of an embodiment of the invention. In the example, a microscope system is configured and validated for operation using preconfigured scene files and an activation process.

First 510, the microscope system is preconfigured with scene files during installation or a subsequent service visit. These scene files may contain predefined imaging parameters, system settings, or calibration data optimized for specific applications. Second 520, an activation process is initiated when a USB storage device containing an activation file is inserted into a USB port of the microscope system. The system detects the presence of the USB device and identifies the corresponding activation file. Third 530, the user accesses the system settings through a GUI to import the activation file from the USB device. Upon successful importation, the system verifies the activation data and validates the preconfigured scene files, enabling their use within the microscope system. The flowchart illustrates a sequential validation method, ensuring that scene files remain inaccessible until the proper activation data has been installed. This process enhances security, system customization, and user control, allowing the microscope system to function according to the validated imaging configurations.

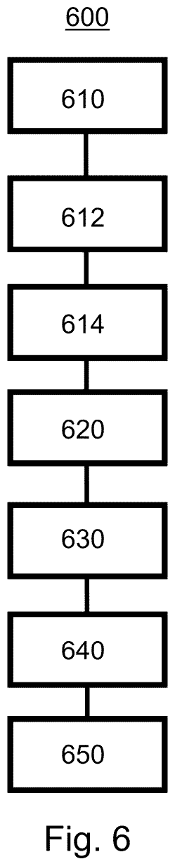

An embodiment of the present invention further provides a validation method for the microscope system. FIG. 6 shows a flowchart of a method 600 for validating scene files in a microscope system. The method comprises capturing images from a microscope 620 and retrieving a plurality of scene files from a storage device 630. The retrieved scene files each comprise a set of image processing parameters, including but not limited to contrast, color, highlights, exposure, shadows, or aperture, which are applied to enhance the captured images. Before application, a scene file is validated using one or more processors 640 to ensure authenticity and compliance with system requirements. Once validated, the scene file is applied to the captured images, and the processed images are displayed on a display 650.

In certain embodiments, validating a scene file requires receiving an activation code 610 before its application. The activation code may be received through multiple secure methods. For example, the activation code may be obtained via a secure network connection with a remote device, such as a server or cloud-based storage system. In another embodiment, the activation code is transmitted over Bluetooth or Wi-Fi from a mobile device running an application configured to manage microscope settings. Alternatively, the activation code may be entered manually via a user interface of the microscope system.

In additional embodiments, the activation code may be acquired through hardware-based methods. The system may retrieve the activation code from a USB dongle inserted into the microscope's USB port. In another implementation, a hardware card may store the activation code, which is extracted via a dedicated card reader connected to the microscope system. Alternatively, the activation code may be obtained by scanning a machine-readable optical code, such as a QR code, using the microscope's integrated image sensor.

The scene file validation process may involve cryptographic verification techniques to ensure security and integrity. In one embodiment, the microscope system extracts an embedded digital signature from the scene file and verifies the signature using a corresponding public key. Alternatively, a cryptographic hash of the scene file is computed and compared against a pre-stored cryptographic hash embedded in the scene file to verify authenticity. Additionally, the system may extract a timestamp from the scene file and compare it with the current system time to determine whether the scene file remains within a predetermined validity window.

In further embodiments, validation of the scene file may involve using a hardware-based security module. The system may communicate with the security module via a secure interface to perform validation, ensuring that scene file usage remains restricted to authorized devices and environments.

Authentication protocols may govern access to validated scene files. In one embodiment, access is restricted based on user authentication, including biometric verification (i.e. fingerprint scanning or facial recognition) or password entry via the microscope's user interface.

In certain implementations, the validation method may integrate with a surgical information system 612 to obtain workflow data. The system may enable access to restricted scene files only during specific surgical workflow steps, ensuring that specialized processing settings are applied at appropriate stages. The microscope system may also automatically switch between validated scene files based on detected workflow steps, optimizing image processing according to the current surgical phase.

In another embodiment, the system detects the microscope's lens configuration 614 and selects a scene file based on the detected lens parameters, ensuring optimal processing for different optical configurations. Furthermore, certain scene file activations may be restricted based on the configuration of the microscope or connected peripherals, preventing unauthorized or incompatible scene file usage.

The validation process may also be customized based on user profiles stored in the system. A user profile may include user-specific parameters determining activation settings and allowable scene file access. This ensures that individual users or groups have personalized access permissions and system configurations suited to their requirements.

In additional embodiments, the microscope system may connect to a remote server to download updated scene files and activation data, ensuring the system remains current with the latest configurations and optimizations. Furthermore, the system may automatically switch between validated scene files based on signals from connected surgical workflow devices, allowing seamless transitions between image processing settings without manual intervention.

In an embodiment of the present invention, a computer program product is also provided, having an executable program code. When the program code is run on a computer device such as a processor, the switching method of the dual camera switching device, as described above, is performed.

In one embodiment of the present invention, an electronic device is provided, including a processor and a memory, wherein, the memory is used to store program instructions, and the processor is configured to run the program instructions, and the program instructions are run to perform the steps performed in the above embodiments.

In one embodiment of the present invention, a computer-readable storage medium is provided for storing program instructions, the program instructions are configured to be called to execute the steps performed in the above embodiments.

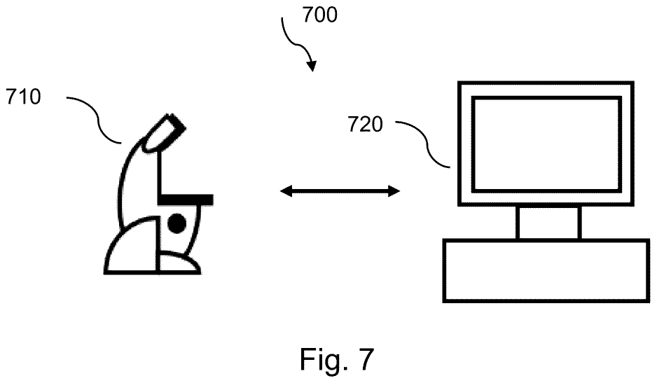

Some embodiments relate to a microscope comprising a system as described in connection with one or more of the FIGS. 1 to 6. Alternatively, a microscope may be part of or connected to a system as described in connection with one or more of the FIGS. 1 to 6. FIG. 7 shows a schematic illustration of a system 700 configured to perform a method described herein. The system 700 comprises a microscope 710 and a computer system 720. The microscope 710 is configured to take images and is connected to the computer system 720. The computer system 720 is configured to execute at least a part of a method described herein. The computer system 720 may be configured to execute a machine learning algorithm. The computer system 720 and microscope 710 may be separate entities but can also be integrated together in one common housing. The computer system 720 may be part of a central processing system of the microscope 710 and/or the computer system 720 may be part of a subcomponent of the microscope 710, such as a sensor, an actor, a camera or an illumination unit, etc. of the microscope 710.

The computer system 720 may be a local computer device (e.g. personal computer, laptop, tablet computer or mobile phone) with one or more processors and one or more storage devices or may be a distributed computer system (e.g. a cloud computing system with one or more processors and one or more storage devices distributed at various locations, for example, at a local client and/or one or more remote server farms and/or data centers). The computer system 720 may comprise any circuit or combination of circuits. In one embodiment, the computer system 720 may include one or more processors which can be of any type. As used herein, processor may mean any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a FPGA, for example, of a microscope or a microscope component (e.g. camera) or any other type of processor or processing circuit. Other types of circuits that may be included in the computer system 720 may be a custom circuit, an application-specific integrated circuit (ASlC), or the like, such as, for example, one or more circuits (i.e. a communication circuit) for use in wireless devices like mobile telephones, tablet computers, laptop computers, two-way radios, and similar electronic systems. The computer system 720 may include one or more storage devices, which may include one or more memory elements suitable to the particular application, such as a main memory in the form of random access memory (RAM), one or more hard drives, and/or one or more drives that handle removable media such as compact disks (CD), flash memory cards, digital video disk (DVD), and the like. The computer system 720 may also include a display device, one or more speakers, and a keyboard and/or controller, which can include a mouse, trackball, touch screen, voice-recognition device, or any other device that permits a system user to input information into and receive information from the computer system 720.

Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may, for example, be stored on a machine readable carrier.

Other embodiments comprise the computer program for performing one of the methods described herein, stored on a machine readable carrier.

In other words, an embodiment of the present invention is, therefore, a computer program having a program code for performing one of the methods described herein, when the computer program runs on a computer.

A further embodiment of the present invention is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitionary. A further embodiment of the present invention is an apparatus as described herein comprising a processor and the storage medium.

A further embodiment of the invention is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment according to the invention comprises an apparatus or a system configured to transfer (e.g. electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (e.g. a FPGA) may be used to perform some or all of the functionalities of the methods described herein.

In some embodiments, a FPGA may cooperate with a microprocessor in order to perform one of the methods described herein. Generally, the methods are preferably performed by any hardware apparatus.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps,-functions,-processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

It is further understood that the disclosure of several steps, processes, operations, or functions disclosed in the description or claims shall not be construed to imply that these operations are necessarily dependent on the order described unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes, or -operations.

If some aspects have been described in relation to a device or system, these aspects should also be understood as a description of the corresponding method. For example, a block, device, or functional aspect of the device or system may correspond to a feature, such as a method step, of the corresponding method. Accordingly, aspects described in relation to a method shall also be understood as a description of a corresponding block, a corresponding element, a property, or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product (e.g. machine-readable instructions, program code, etc.). Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g. via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect, feature, or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although, in the claims, a dependent claim refers to a particular combination with one or more other claims, other examples may also include a combination of the dependent claim with the subject matter of any other dependent or independent claim. Such combinations are hereby explicitly proposed unless it is stated in the individual case that a particular combination is not intended. Furthermore, features of a claim should also be included for any other independent claim, even if that claim is not directly defined as dependent on that other independent claim.

What is claimed is:

1. A microscope system, comprising:
a microscope for capturing images;
a storage device for a plurality of scene files;
one or more processors configured to:
validate a scene file of the plurality of scene files, and
apply one of the validated scene files to the microscope system; and
a display for presenting the captured images.

2. The microscope system of claim 1, wherein each scene file comprises a set of image processing parameters.

3. The microscope system of claim 2, wherein the set of image processing parameters comprises at least one of contrast, color, highlights, exposure, shadows, or aperture.

4. The microscope system of claim 1, wherein the one or more processors are further configured to receive an activation code and validate the scene file based on the activation code.

5. The microscope system of claim 4, wherein the one or more processors are further configured to receive the activation code via a secure connection with a remote device.

6. The microscope system of claim 4, wherein the secure connection is a network connection and the one or more processors are further configured to receive the activation code from a server.

7. The microscope system of claim 5, wherein the secure connection is at least one of a Bluetooth or Wi-Fi connection, the remote device is a mobile device, and the one or more processors are further configured to receive the activation code from a mobile application running on the mobile device.

8. The microscope system of claim 4, wherein the one or more processors are further configured to receive the activation code entered via a user interface of the microscope system.

9. The microscope system of claim 4, wherein the one or more processors are further configured to receive the activation code via a hardware device inserted into the microscope system.

10. The microscope system of claim 9, wherein the system further comprises a reader for a hardware card comprising the activation code, wherein the one or more processors are further configured to validate the activation code using the hardware card.

11. The microscope system of claim 1, wherein each scene file comprises an embedded digital signature, and the one or more processors are configured to validate the scene file by extracting the digital signature and verifying it using a corresponding public key.

12. The microscope system of claim 1, wherein each scene file comprises a cryptographic hash, and the one or more processors are configured to compute a cryptographic hash of the scene file and compare the computed hash with the cryptographic hash embedded in the scene file.

13. The microscope system of claim 1, wherein each scene file includes a timestamp, and the one or more processors are configured to validate the scene file by comparing the embedded timestamp with the current system time to determine whether the scene file falls within a predetermined validity window.

14. The microscope system of claim 1, further comprising a hardware-based security module for validating scene file of the plurality of scene files, and wherein the one or more processors are configured to communicate with the hardware-based security module via a secure interface to perform validation of the scene file.

15. The microscope system of claim 1, wherein the one or more processors are further configured to enforce access restrictions to the scene file based on user authentication, the authentication comprising at least one of biometric verification or password entry.

16. The microscope system of claim 1, wherein the one or more processors are further configured to interface with a surgical information system to obtain workflow data, the one or more processors are enabling access to the restricted scene file only during predetermined surgical workflow steps.

17. The microscope system of claim 1, wherein the one or more processors are further configured to detect a lens configuration of the microscope and to select a scene file based on the detected lens configuration.

18. The microscope system of claim 1, wherein the one or more processors are further configured to restrict activation of the scene file based on the configuration of the microscope or a connected peripheral.

19. A method for processing microscope images, comprising:
capturing images from a microscope;
retrieving a plurality of scene files from a storage device;
validating a scene file of the plurality of scene files using one or more processors;
applying the validated scene file to the microscope system; and
displaying the captured images on a display.

20. A tangible, non-transitory computer-readable medium having instructions thereon, which, upon execution by one or more hardware processors, facilitates execution of the following steps:
capturing images from a microscope;
retrieving a plurality of scene files from a storage device;
validating a scene file of the plurality of scene files using one or more processors;
applying the validated scene file to the microscope system; and
displaying the captured images on a display.
